(19) United States
(12) Patent Application Publication
(10) Pub. No.: US 2018/0291794 A1
(43) Pub. Date: Oct. 11, 2018

(54) Double Thin Wall Conduit Hanger

(71) Applicant: Tenneco Automotive Operating Company Inc., Lake Forest, IL (US)

(72) Inventors: Edward C. HILL, Jackson, MI (US); John KOLESZAR, Perry, MI (US); Creig BIGELOW, Jackson, MI (US)

(21) Appl. No.: 15/480,830

(22) Filed: Apr. 6, 2017

(51) Int. Cl. F01N 13/18; B60K 13/04

(52) U.S. Cl. CPC F01N 13/1805; F01N 2450/22; B60Y 2410/124; B60K 13/04

(57) ABSTRACT

An exhaust assembly for a vehicle includes a hanger and an exhaust pipe assembly. The hanger is configured to be fixed to a body of the vehicle. The exhaust pipe assembly includes a first portion and a second portion. The first portion is at least partially disposed inside the second portion so that the second portion overlaps the first portion at a joining region. The joining region has a first outer diameter and is flanked by outer regions having a second outer diameter that is greater than the first outer diameter. An interference fit may be provided between the first portion and the second portion. The hanger is joined to an outer surface of the exhaust pipe assembly at the joining region.

### FIELD

The present disclosure relates to vehicle exhaust assemblies and the interconnection between the vehicle exhaust assembly and the vehicle body.

### BACKGROUND

This section provides background information related to the present disclosure which is not necessarily prior art.

Many vehicles are equipped with structures identified as exhaust hangers for fixing exhaust systems to a vehicle body or frame. Some exhaust hangers include a flexible element, such as a rubber or silicone isolator. The exhaust hanger may include a straight portion extending from the flexible isolator called the perch. The perch is the loading point for the hanger assembly. The perch may be a hollow or solid rod that can be bent into required shapes. Several exhaust hangers may be distributed along the length of an exhaust, increasing cost and complexity of the system. Exhaust hangers having longer perches may suffer from poor noise, vibration and harshness (NVH) performance.

There is an increasing desire for vehicles having improved NVH refinement, i.e., higher first mode frequency, and reduced mass while maintaining acceptable durability performance. Thus, other exhaust hangers include a bracket, which may have a triangular cross section, attached to the exhaust, and a rod attached to the bracket for fixing the exhaust to the vehicle body or frame. Rod and bracket hangers may be used when it is necessary to meet high frequency targets. Rod and bracket hangers may require a unique design for each location. The need for multiple designs can thereby increase cost and complexity.

While previously implemented exhaust hangers may have satisfactorily functioned in the past, strides may be made to reduce mass, increase durability, reduce NVH characteristics, and improve ease of manufacturing and assembly. Accordingly, a need exists for an improved exhaust hanger and exhaust hanger assembly process for providing a robust exhaust hanger.

### SUMMARY

This section provides a general summary of the disclosure, and is not a comprehensive disclosure of its full scope or all of its features.

In accordance with an aspect of the subject disclosure, an exhaust assembly for a vehicle is provided. The exhaust assembly includes a hanger an exhaust pipe assembly. The hanger is configured to be fixed to a body of the vehicle. The exhaust pipe assembly includes a first portion and a second portion. The first portion is at least partially disposed inside the second portion so that the second portion overlaps the first portion at a joining region. The joining region has a first outer diameter and is flanked by outer regions having a second outer diameter that is greater than the first outer diameter. The hanger is joined to an outer surface of the exhaust pipe assembly at the joining region.

In another aspect of the subject disclosure, an exhaust assembly for a vehicle is provided. The exhaust pipe assembly includes a hanger joined to an outer surface of an exhaust pipe assembly. The exhaust pipe assembly includes a first portion and a second portion in fluid communication with and sealingly coupled to the first portion. The second portion overlaps the first portion at a joining region. An interference fit is provided between the first portion and the second portion. The joining region has a first outer diameter. The joining region is disposed between outer regions having a distinct second outer diameter.

In still another aspect of the subject disclosure, a method of assembly an exhaust assembly for a vehicle is provided. The method includes partially inserting a first exhaust pipe component into a second exhaust pipe component to form a joining region. A diameter of at least a portion of the second exhaust pipe component is reduced at the joining region to define an interference fit. The first exhaust pipe component is sealingly coupled to the second exhaust pipe component to form an exhaust pipe assembly. A hanger is attached to an outer surface of the exhaust pipe assembly at the joining region.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a partial perspective view of an exhaust hanger assembly constructed in accordance with the subject disclosure;

FIG. 2 shows a front perspective view of a rod and clip subassembly of the exemplary exhaust hanger assembly of FIG. 1;

FIG. 3 shows a back perspective view of the rod and clip subassembly of FIG. 2;

FIG. 4 is a perspective view of a bracket of the exemplary exhaust hanger assembly of FIG. 1;

FIG. 5 is a side view of the exemplary exhaust hanger assembly shown in FIG. 1;

FIG. 6 is a partial perspective view of another exhaust hanger assembly constructed in accordance with the subject disclosure;

FIG. 7 is a first side view of the exemplary exhaust hanger assembly of FIG. 6;

FIG. 8 is a second side view of the exemplary exhaust hanger assembly of FIG. 6;

FIG. 9 is a front perspective view of a rod and clip subassembly of the exemplary exhaust hanger assembly of FIG. 6;

FIG. 10 shows a back perspective view of the rod and clip subassembly of FIG. 9;

FIG. 11 is a side view of another exhaust hanger assembly constructed in accordance with the subject disclosure;

FIG. 12 is a front cross-sectional view of the exhaust hanger assembly of FIG. 11;

FIG. 13 is a side view of another exhaust hanger assembly constructed in accordance with the subject disclosure;

FIG. 14 is a front cross-sectional view of the exhaust hanger assembly of FIG. 13;

FIG. 15 is a side view of another exhaust hanger assembly constructed in accordance with the subject disclosure;

FIG. 16 is a front cross-sectional view of the exhaust hanger assembly of FIG. 15;

FIG. 17 is a perspective view of an exemplary exhaust hanger assembly showing stress regions constructed in accordance with the subject disclosure;

FIG. 18 shows stress testing results for an exhaust hanger assembly having a unitary exhaust pipe;

FIG. 19 shows stress testing results for an exhaust hanger assembly having first and second exhaust pipe portions connected by an interference fit; and

FIG. 20 shows stress testing results for an exhaust hanger assembly having first and second exhaust pipe portions connected by a slip fit.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

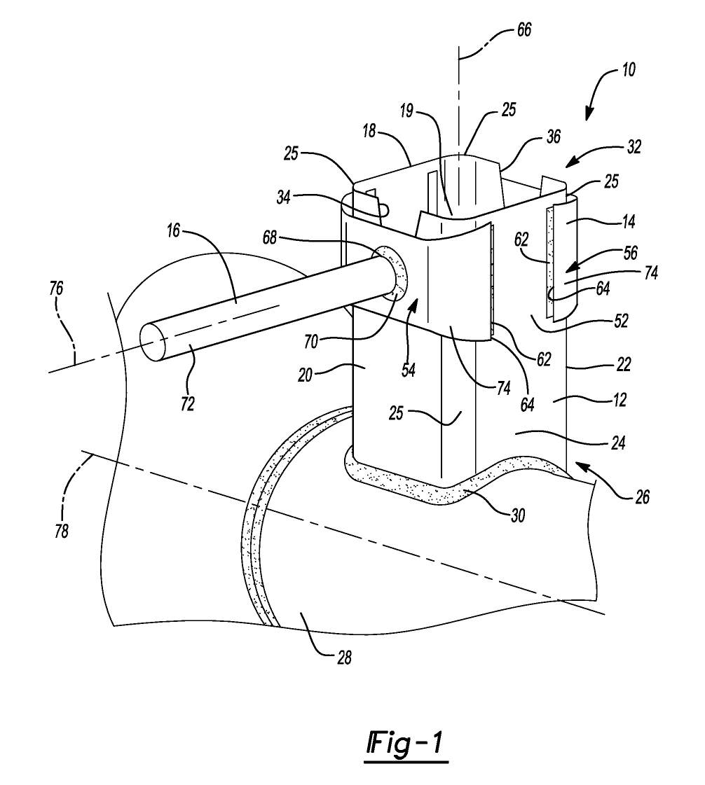

It should generally be appreciated that automotive exhaust hangers provide a means to attach an exhaust system to a vehicle body or frame. Several exhaust hangers may be distributed along the length of the exhaust, depending on the length and mass of the exhaust, to provide adequate support. With reference to FIG. 1, an example exhaust hanger assembly 10 according to the principles of the present disclosure is provided. The exhaust hanger assembly 10 generally includes a bracket 12, a clip 14, and a rod 16.

The bracket 12 includes a peripheral wall 18, which may be thin and may define a hollow interior 19. The peripheral wall 18 may have a polygonal cross section, such as a triangular, rectangular, or square cross section, by way of non-limiting example. The peripheral wall 18 may include a front portion which may be a front wall 20, a back portion which may be a back wall 22, and one or more side walls which may be opposing side walls 24. A peripheral wall having a square or box cross section has a desirably high stiffness to mass ratio. Each side wall 24 is adjacent to the front wall 20 and the back wall 22. The peripheral wall 18 may include rounded corners 25.

The bracket 12 may be a folded plate having single weld seam (not shown). The bracket 12 includes a first or bottom end 26 configured to be fixed to an exhaust pipe 28 of a vehicle. For example, the first end 26 of the bracket 12 may be fixed to the exhaust pipe 28 by a weld 30.

The bracket 12 further includes a second end 32. The second end 32 includes a first receiver 34 and a second receiver 36. The first and second receivers 34, 36 may be slots, as shown. In another example, the first and second receivers 34, 36 may be oversized (i.e., having a dimension greater than an outer diameter of the rod 16) apertures (not shown). The first receiver 34 may be formed in the front wall 20 and the second receiver 36 may be formed in the back wall 22. The first and second receivers 34, 36 may be disposed at centers of the front and back walls 20, 22, respectively. As best shown in FIG. 4, the first and second receivers 34, 36 may include a rounded portion 38, an angled portion 40, and a straight portion 42 disposed between the rounded portion 38 and the angled portion 40. The rounded portion 38 has a diameter 44. The straight portion 42 has a uniform width 46 that is equal to the diameter 44. The angled portion 40 increases from a first width 48 that is equal to the diameter 44 to a second width 50 greater than the first width 48. The second width may be greater than or equal to the first width. For example, the second width 50 may be greater than or equal to 1.2 times the first width 48 to less than or equal to 1.6 times the first width 48. The first and second receivers 34, 36 may comprise other geometries within the scope of the present disclosure. For example, the first and second receivers 34, 36 may comprise only a rounded portion 38 and a straight portion 42 (not shown).

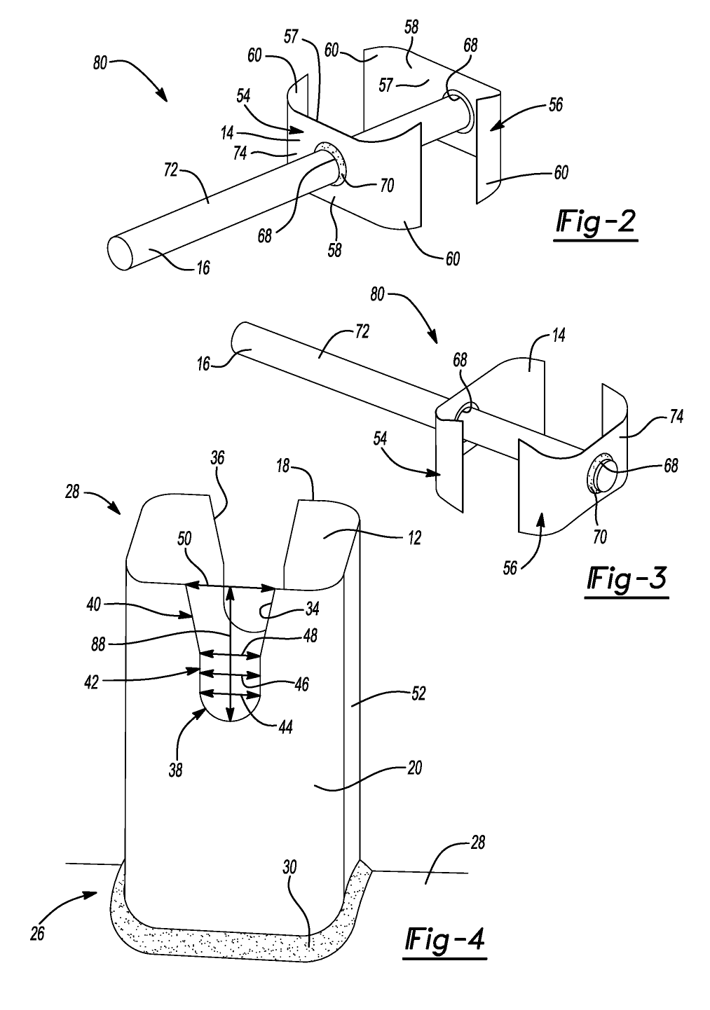

The clip 14 may be disposed around at least a portion of an outer surface 52 of the bracket 12 and fixed to the bracket 12. The clip 14 may include a front portion 54 disposed around the front wall 20 and a back portion 56 disposed around the back wall 22. The clip 14 may include an inner surface 57 that is shaped to complement the outer surface 52 of the bracket 12. For example, when the peripheral wall has a rectangular cross section, each of the front and back portions 54, 56 of the clip 14 may be substantially U-shaped such that they include a base 58 and opposing arms 60 extending from opposite sides of the base 58, as best shown in FIGS. 2-3. Returning to FIG. 1, the respective bases 58 of the front and back portions 54, 56 of the clip 14 may be disposed parallel to the respective front and back walls 20, 22 of the bracket 12. The arms 60 of the clip 14 may wrap around the corners 25 of the bracket 12 and extend partially across the opposing side walls 24 of the bracket 12.

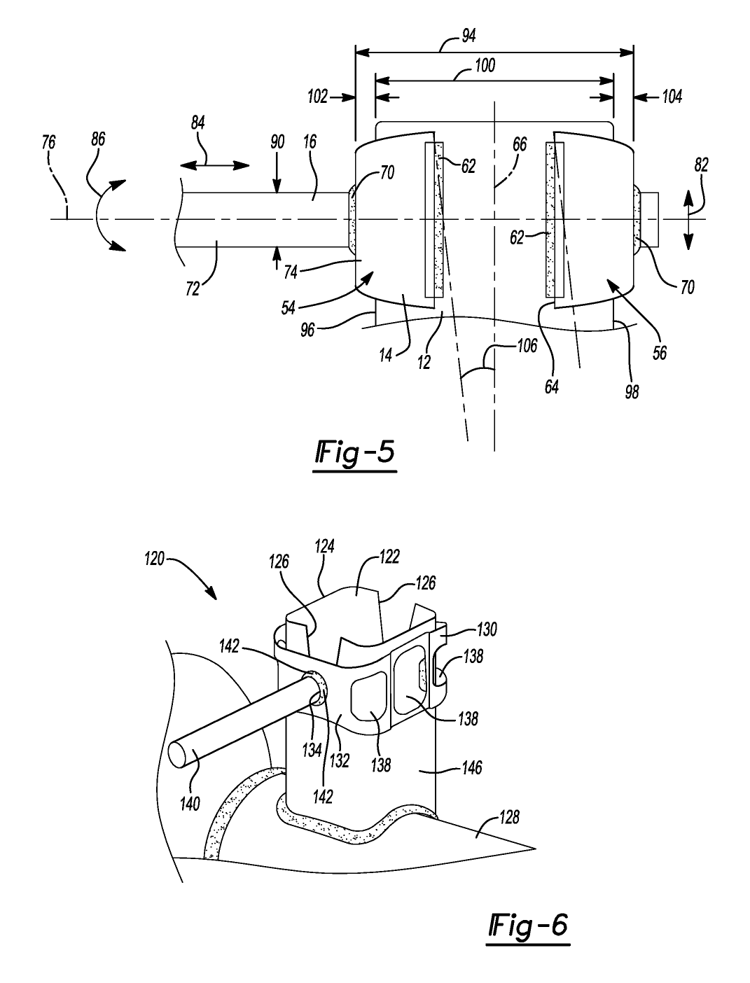

The clip 14 may be fixed to the bracket 12 by a plurality of welds 62, as depicted in FIGS. 1 and 5. More specifically, the plurality may comprise four welds 62 and each weld 62 may join an edge 64 of the clip 14 to the outer surface 52 of the bracket 12. The plurality of welds 62 may be substantially vertical or parallel to a first longitudinal axis 66 of the bracket 12. Vertical welds are in the line of the applied load, thus, they exhibit a higher durability and a more uniform stress concentration when compared to horizontal welds, for example.

The rod 16 is configured to be fixed to a body of the vehicle (not shown). The rod 16 may be of solid construction, or it may have a hollow interior, depending on durability, frequency, and weight requirements of the exhaust hanger assembly 10. The rod 16 may extend through the first and second receivers 34, 36 of the bracket 12. Thus, the rod 16 may be disposed within the first and second receivers 34, 36. The rod 16 may also extend through opposing apertures 68 of the clip 14 so that it is supported by the clip 14 at the apertures 68. Thus, the rod 16 may have a two-point support.

The rod 16 may be joined to the clip by welds 70. The welds 70 may be 360° circular welds. More specifically, the welds 70 may join an outer surface 72 of the rod 16 to respective outer surfaces 74 of the front and back portions 54, 56 of the clip 14. By using welds 70 on two points of contact of the clip 14, strength for lateral loads and first mode frequency is improved as compared to a single point support. For example, the natural frequency of a two point support design may be increased by greater than or equal to about 200% compared to a single point support design.

The rod 16 may include a second longitudinal axis 76 and the exhaust pipe 28 may include a third longitudinal axis 78. Each of the first longitudinal axis 66, the second longitudinal axis 76, and the third longitudinal axis 78 may be substantially perpendicular to one another.

In other examples, the rod 16 and the clip 14 may be provided as a subassembly 80. The subassembly may be used with different rods and clips. That is, the rod and clip subassembly 80 may be used as a universal part.

Referring now to FIGS. 2-4, a method of assembling the exhaust hanger 10 of FIG. 1 is provided. A rod and clip subassembly 80 is shown in FIGS. 2-3. The rod and clip subassembly 80 includes the front and back portions 54, 56 of the clip 14 joined to the rod 16, as described above. Because the rod 16 and the clip 14 can be preassembled, the welds 70 can be readily formed as 360° circular welds. This is possible because the outer surface 72 of the rod 16 and the outer surface 74 of the clip 14 are accessible without interference of the exhaust pipe 28 or other vehicle components.

With reference to FIG. 4, the bracket 12 is shown joined to the exhaust pipe 28. Although the bracket 12 is shown joined to the exhaust pipe 28 prior to assembly with the rod and clip subassembly 80, the steps may be completed in a different order within the scope of the present disclosure. For example, the exhaust hanger assembly 10 may be joined to the exhaust pipe 28 after the rod and clip subassembly 80 is joined to the bracket.

The rod and clip subassembly 80 is placed into the first and second receivers 34, 36 of the bracket 12 so that the clip 14 at least partially surrounds the outer surface 52 of the bracket 12. The rod and clip subassembly 80 is then aligned, as described in greater detail below. After the rod and clip subassembly 80 is properly aligned, it is joined to the bracket 12, for example, by a welding, as described above. Although the rod 16 and the clip 14 are described as being preassembled, they may alternatively be joined together at a different point in the method. For example, the rod 16 may be joined to the clip 14 after insertion of the rod 16 in the first and second receivers 34, 36 and placement of the clip 14 or after alignment.

As best shown in FIG. 5, the rod and clip subassembly 80 can be adjusted in three directions during alignment, allowing considerable assembly freedom by accommodating assembly stack-up tolerances in a first direction 82 parallel to the first longitudinal axis, a second direction 84 parallel to the second longitudinal axis 76, and a third direction or tilt 86.

First, the subassembly 80 can be moved up and down within the first and second receivers 34, 36 to be adjusted in the first direction 82. The flexibility of assembly in the first direction 82 is enabled by the length of the first and second receivers 34, 36. For example, the first and second receivers 34, 36 may have a length 88 that is greater than a diameter 90 of the rod 16.

The subassembly 80 is also adjustable in the second direction 84. The opposing inner surfaces 57 of the clip 14 define a first dimension 94. The front and back wall 54, 56 include opposing outer surfaces 96, 98, respectively, that define a second dimension 100. The first dimension 94 may be greater than the second dimension 100. Thus, a first gap 102 is defined between the inner surface 57 of the clip 14 and the outer surface 96 of the bracket 12 and a second gap 104 is defined between the inner surface 57 of the clip and the outer surface 98 of the bracket. The difference in magnitude of the first and second gaps 102, 104 enables adjustment of the subassembly 80 in the second direction 84. The first and second gaps 102, 104 also allow the subassembly 80 to be paired with brackets 12 of different sizes.

Finally, the subassembly 80 can be tilted in the third direction 86 within the first and second receivers 34, 36. The degree of adjustment in the third direction is dependent on the length 88 of the first and second receivers 34, 36. A tilt angle 106 is formed between the first longitudinal axis 66 and one of the side edges 64 of the clip 14. The tilt angle 106 may be greater than or equal to about −−5° to less than or equal to about +5°. Because the tilt angle 106 is small, the welds 62 remain substantially vertical.

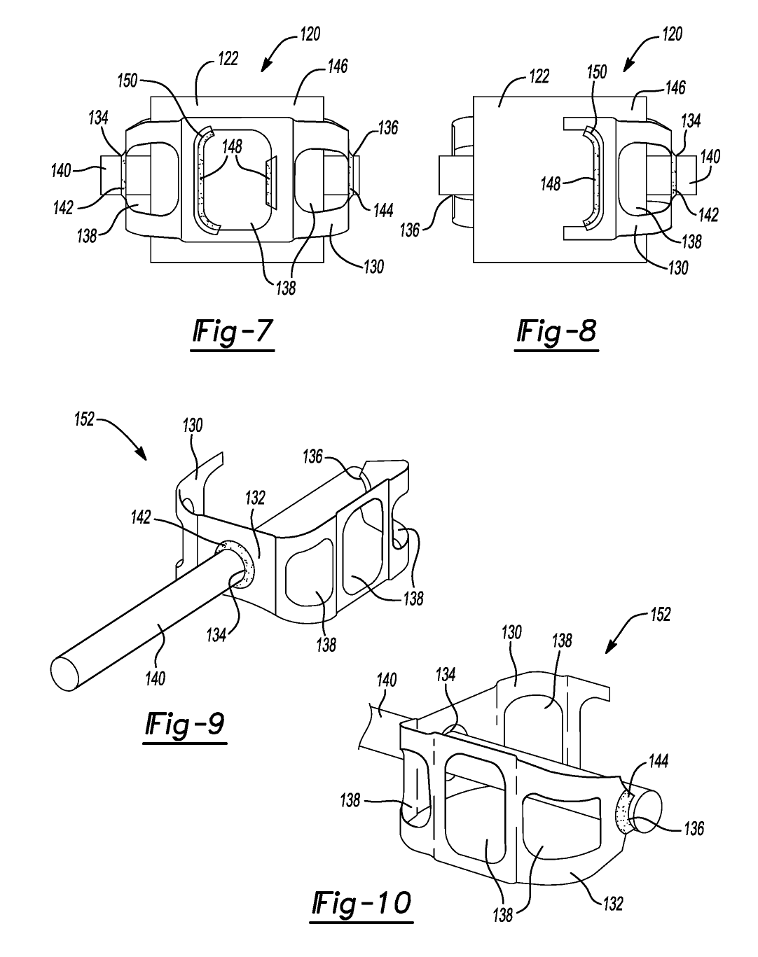

Referring now to FIGS. 6-10, another example exhaust hanger assembly 120 according to certain principles of the present disclosure is provided. The exhaust hanger assembly 120 includes a bracket 122 having a peripheral wall 124 and receivers 126, similar to the bracket 12 of the exhaust hanger 10 of FIG. 1. The bracket 122 is welded to an exhaust pipe 128 similar to the exhaust pipe 28 of FIG. 1.

The clip 130 comprises a single piece or unitary body 132. The clip 130 includes a first support 134, which may be a surface of an aperture, and a second support 136, which may be a surface of a semi-circular pocket. In other examples, the first and second supports 134, 136 may both be apertures. The unitary body 132 may include one or more weight reduction openings 138.

The exhaust hanger assembly 120 further includes a rod 140 similar to the rod 16 of the exhaust hanger assembly 10 of FIG. 1. The rod extends through the first and second supports 134, 136 of the clip 130 and is supported by the clip 130. Thus, the rod 140 uses the advantageous two-point support described above. The rod 140 is joined to the clip 130 by first and second welds 142, 144. The first weld 142 joins the rod 140 to the clip 130 at a location adjacent to the first support 134 of the clip. The first weld 142 may be a 360° circular weld. The second weld 144 joins the rod 140 to the clip 130 at the second support 136 of the clip. The second weld 144 may be a semi-circular weld. In some examples, the rod 140 and the clip 130 may be joined by a press-fit rather than welds (not shown).

The clip 130 is disposed at least partially around a surface 146 of the bracket 122. The rod 140 is disposed within the receivers 126 of the bracket 122. The clip 130 is joined to the bracket 122 by a plurality of welds 148. The welds 148 may be disposed adjacent to edges of the clip 130 or edges of the weight reduction openings 138. The welds 148 may be substantially vertical. In some examples, substantially vertical welds 148 extend at least partially around a corner 150 of the weight reduction opening 138 or clip 130.

The exhaust hanger assembly 120 can be assembled using a method similar to the method described in FIGS. 2-4 above. Specifically, a rod and clip subassembly 152 may be assembled first. The receivers 126 of the bracket 122 and dimensions of the bracket 122 and clip 130 enable adjustment and tolerance stack-up in three directions, as described above.

The exhaust hanger assemblies of FIGS. 1-10 may be light-weight and durable. First, the two-point support of the rod and clip subassembly enables use of the peripheral wall's stiffness. The vertical welds joining the clip to the bracket offer ample area to transfer the loads carried by the rod and clip to the bracket. For example, the reduction in stress due to the two-point support may be greater than or equal to about 75% as compared to a single-point support. Second, the weld lines joining the clip to the bracket are substantially vertical and are therefore aligned with the primary direction of loading. Thus, the weld orientation enables distribution of the shear loads from the primary direction of loading over a large area. The low stress concentration leads to high durability performance for a given load. In some examples, the low stress concentration enables the use of thin materials for a given stress, leading to a light-weight design and better fuel economy.

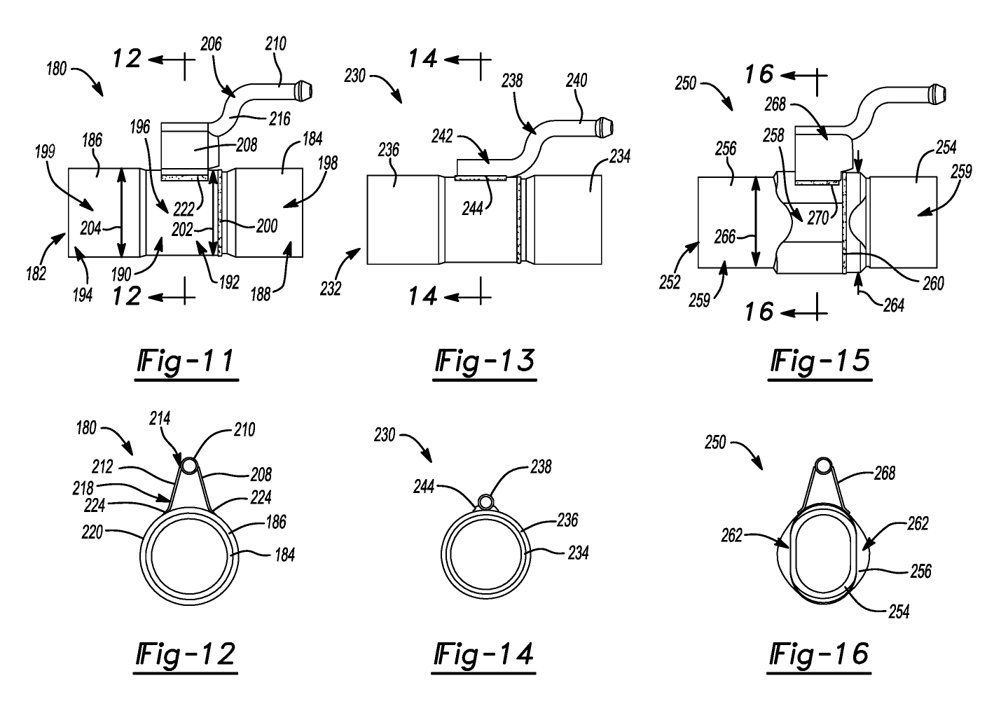

With reference to FIGS. 11-16, additional examples of exhaust assemblies according to certain principles of the present disclosure are provided. The exhaust assemblies of FIGS. 11-16 are light-weight. More specifically, each of the example exhaust assemblies includes a thin-walled exhaust pipe assembly having at least two exhaust pipe portions. Light weight exhaust assemblies are desirable to increase fuel economy of the vehicle. However, thin-walled exhaust pipes can be problematic due to high stress risers at joining end points and possible burn-through in the case of welded joints. The exhaust assemblies of the present disclosure include an overlap of the thin-walled pipes at the joining region to provide increased strength and thickness.

Referring to FIGS. 11-12, an example exhaust assembly 180 is provided in accordance with certain aspects of the present disclosure. The exhaust assembly 180 includes an exhaust pipe assembly 182 having a first portion 184 and a second portion 186. The first portion includes first and second ends 188, 190. The second portion 186 includes first and second ends 192, 194. The first portion 184 is at least partially disposed in the second portion 186 so that the second portion 186 overlaps the first portion 184 at a joining region 196. More specifically, the second end 190 of the first portion 184 is connected to the first end 192 of the second portion 186 so that the first and second portions 184, 186 are in fluid communication.

The joining region 196 is flanked by outer regions 198. Because of the overlap, a first total wall thickness at the joining region 196 is greater than second and third total wall thicknesses at the outer regions 198, 199 of the first and second portions 184, 186, respectively. By way of non-limiting-example, the first total wall thickness may be greater than or equal to about 0.8 mm to less than or equal to about 1.6 mm, optionally about 1.2 mm. The second and third total wall thicknesses may each be greater than or equal to about 0.4 mm to less than or equal to about 0.8 mm, optionally about 0.6 mm. The second and third wall thicknesses may be the same or different. In one example, the second total wall thickness is 0.6 mm and the third total wall thickness is 0.8 mm. In another example, the second and third total wall thicknesses are both 0.6 mm. The combined total wall thickness (i.e., the first total wall thickness at the joining region 196) enables a distribution of load and stress. Furthermore, it decreases the possibility of burn through during welding.

The first portion 184 of the exhaust pipe assembly 182 may be sealingly coupled to the second portion 186 of the exhaust pipe assembly 182 by a 360° weld 200 to prevent exhaust gas leakage. In other examples, the first portion 184 of the exhaust pipe assembly 182 may be sealingly connected to the second portion 186 of the exhaust pipe assembly 182 by brazing or other joining methods. An interference fit may be provided between the first portion 184 and the second portion 186 prior to further joining the first portion 184 to the second portion 186. The interference fit creates a stiffer member in the joining region 196.

The joining region 196 has a first outer diameter 202 and the outer regions 198 may have a second outer diameter 204 that is distinct from the first outer diameter 194. The first outer diameter 202 may be smaller than the second outer diameter 204. The smaller first outer diameter 202 may provide increased stiffness when compared to an exhaust pipe assembly having a uniform diameter.

The exhaust assembly 180 further includes a hanger 206. The hanger 206 includes a frame 208 and a wire 210. The frame 208 may have a triangular cross section comprising opposing legs 212. Each leg 212 may include a first edge 214 joined to an outer surface 220 of the wire 210 and a second edge 218 fixed to an outer surface 220 of the exhaust pipe assembly 182 at the joining region 196. The frame 208 may be fixed to the exhaust pipe assembly 182, for example, by horizontal welds 222. The second edges 214 may include feet 224.

With reference to FIGS. 13-14, another example exhaust assembly 230 is provided. The exhaust assembly includes an exhaust pipe assembly 332 having first and second portions 234, 236 similar to the first and second portions 184, 186 of the exhaust pipe assembly 182 of the exhaust assembly 180 of FIGS. 11-12. The exhaust assembly 230 further includes a hanger 238 comprising a wire 240. The wire 240 has a straight region 242. The straight region 242 of the wire 240 is fixed to the exhaust pipe assembly 232 by horizontal welds 244.

Referring now to FIGS. 15-16, another example exhaust assembly 250 according to certain aspects of the present disclosure is provided. The exhaust assembly 250 includes an exhaust pipe assembly 252 having a first portion 254 and a second portion 256. The first portion 254 is inserted into the second portion 256 so that the second portion 256 overlaps the first portion 254 at a joining region 258. The first and second portions 254, 256, may be sealingly coupled by a circular weld 260 or brazing (not shown).

One or both of the first and second portions 254, 256 may include formed wall regions 262 to provide extra stiffness. For example, the formed wall regions 262 may be thinner than surrounding regions, as shown, or the formed wall regions 262 may be thinner than surrounding regions. Moreover, the first and second portions 254, 256 may have non-circular cross sections for increased stiffness. For example, an outer surface of the first portion 254 and an inner surface of the second portion 256 may have oval-shaped cross sections. Other arrangements of formed wall regions 262 and cross sections are contemplated within the scope of the present disclosure.

The joining region 258 has a first outer diameter 264. The joining region is flanked by outer regions 259 having a second outer diameter 266. The first and second outer diameters 264, 266 may be distinct. For example, the first outer diameter 264 may be greater than the second outer diameter 266.

The exhaust assembly 250 further includes a hanger 268 similar to the hanger 206 of the exhaust assembly 180 of FIGS. 11-12. The hanger 268 may be fixed to the exhaust pipe assembly 252 by horizontal welds 270.

In certain aspects, the present disclosure provides a method of assembly an exhaust assembly. The method may be used to manufacture exhaust assemblies having distinct first and second outer diameters, such as exhaust assemblies 180, 230, 250 described above.

The method generally includes partially inserting an end of a first exhaust pipe component into an end of a second exhaust pipe component so that the second exhaust pipe component overlaps the first exhaust pipe component at a joining region. The method further includes creating a joining region having an outer diameter that is distinct from the outer regions. In one example, the second exhaust pipe component is reduced in diameter at the joining region to create an interference fit and a smaller outer diameter in the joining region than in the outer regions. In another example, the first exhaust pipe component is increased in diameter to create an interference fit and a larger outer diameter in the joining region than in the outer regions. In yet another example, the second exhaust pipe component is reduced in diameter and the first exhaust pipe component is increased in diameter at the joining region to create an interference fit.

After creating the interference fit, the first and second exhaust pipe components are mechanically sealed, for example by welding or brazing, to form an exhaust pipe component. A hanger, which may include a wire or a wire fixed to a frame or bracket, is attached to a surface of the joining region, for example, by welding.

### Example 1

Exhaust hanger assemblies according to certain aspects of the present disclosure, such as exhaust assemblies 180, 230, 250 may exhibit improved distribution of stress. More specifically, exhaust hanger assemblies of the present disclosure may distribute the high stress risers at the joining end points.

Assembly 1 is a control assembly. Assembly 1 includes a single-piece exhaust pipe having a substantially uniform 0.6 mm wall thickness. A hanger, similar to the hanger 206 of FIGS. 11-12, is attached to the single-piece exhaust pipe at the center section. The center section has a smaller outer diameter than outer regions surrounding the center section.

Assembly 2 is similar to the exhaust assembly 180 of FIGS. 11-12 in that it includes first and second exhaust pipe portions overlapping to form a joining region and having an interference fit. The pipes each have a 0.6 mm wall thickness. Thus, at a joining region, the total wall thickness is about 1.2 mm. The first and second exhaust pipe sections are sealingly coupled by a 360° weld. The joining region includes a smaller outer diameter than the surrounding outer regions. Assembly 2 includes an attached hanger similar to the hanger 206 of FIGS. 11-12.

Assembly 3 includes first and second exhaust pipe portions overlapping to form a joining regions and having a slip fit. Assembly 3 is otherwise similar to the exhaust assembly 180 of FIGS. 11-12. The pipes each have a 0.6 mm wall thickness. More specifically, there is a 0.7 mm gap between an outer surface of the second portion and an inner surface of the first portion. The first and second exhaust pipe portions are sealingly coupled by a 360° weld. The joining region includes a smaller outer diameter than the surrounding outer regions. Assembly 3 includes an attached hanger similar to the hanger 206 of FIGS. 11-12.

The hangers of Assemblies 1, 2, and 3 are constructed from 409 stainless steel. Assemblies 1, 2, and 3 each include exhaust pipes or exhaust pipe portions having a 57.15 mm outer diameter prior to decreasing the diameter at the joining region. The exhaust pipes or exhaust pipe portions are also constructed from 409 stainless steel. In assemblies 2 and 3, the joining region extends 20 mm on each of the first and second exhaust pipe portions, which are joined by a 360° weld having a 3 mm fillet.

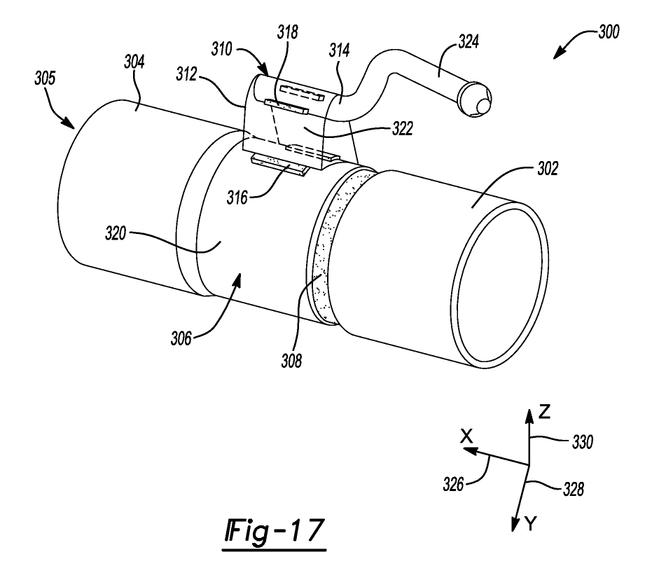

Referring now to FIG. 17, an exhaust assembly 300 similar to the exhaust assembly 180 of FIGS. 11-12 is shown. The exhaust assembly 300 generally includes first and second exhaust pipe portions 302, 304 to form an exhaust pipe assembly 305, a joining region 306, and a 360° weld 308 sealingly coupling the first and second exhaust pipe portions 302, 304. The exhaust assembly 300 also includes an attached hanger 310 comprising a frame 312 and a wire 314. The frame 312 of the hanger 310 is joined to the exhaust pipe assembly 305 at the joining region 306 by welds 316.

In the experiment, stress is measured at 6 locations. Location 1 is the weld 316 that attaches the frame 312 of the hanger 310 to the joining region 306 of the exhaust pipe assembly 305. Location 2 is a weld 318 attaching the wire 314 to the frame 312. Location 3 is the 360° weld 308 sealingly coupling the first and second exhaust pipe portions 302, 304. Location 4 is a base material 320 at the joining region 306 of the exhaust pipe assembly 305. Location 305 is a base material 322 of the frame 312 of the hanger 310. Location 6 is a base material 324 of the wire 312. The x-axis is shown at 326, the y-axis is shown at 328, and the z-axis is shown at 330.

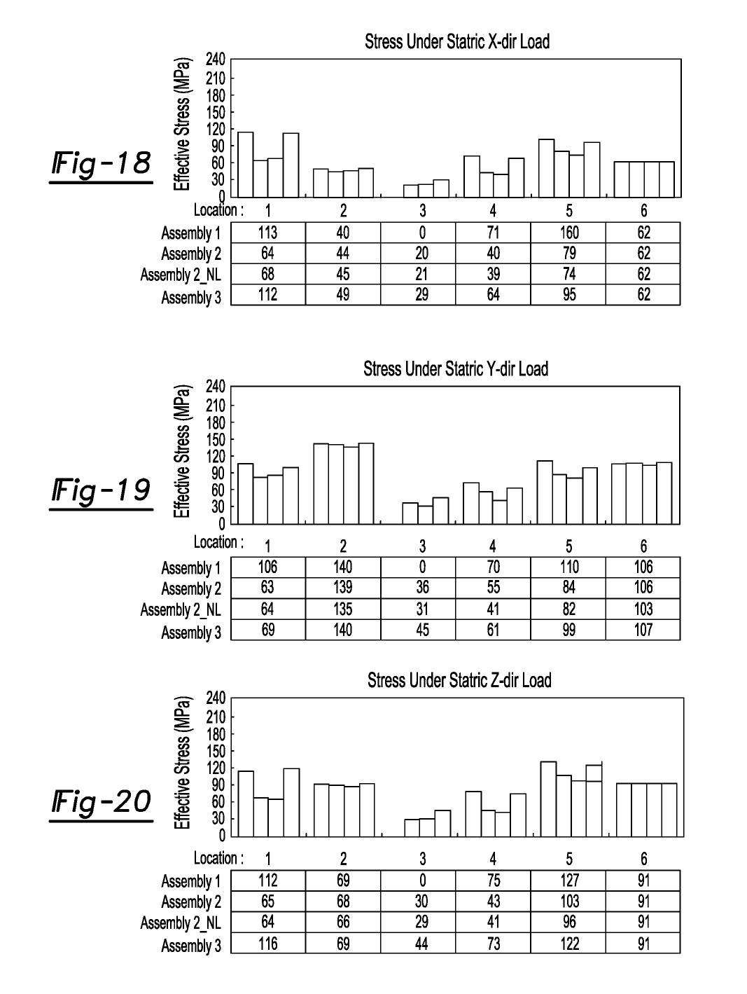

With reference to FIGS. 18-20, effective stress in MPa is shown at each of Locations 1-6 for each of Assemblies 1-3. Assembly 2 is analyzed in two ways, first under linear finite element analysis (FEA), then under non-linear FEA to account for the stiffness from the interference sizing between first and second exhaust pipe portions. Assemblies 1 and 3 are each analyzed under linear FEA. The linear FEA analyses are indicated as “Assembly 1,” “Assembly 2,” and “Assembly 3,” respectively in FIGS. 18-20. The non-linear FEA of Assembly 2 is labeled “Assembly 2_NL” in FIGS. 18-20.

FIG. 18 shows stress under static x-direction loading, FIG. 19 shows stress under static y-direction loading, and FIG. 20 shows stress under static z-direction loading. The analysis shows that with loading input in the x-, y-, and z-directions, at Location 1 in each of the Assemblies 1-3, the stress is distributed in this area. Generally, stress is lowest in Assembly 2 for each direction of loading and at each of Locations 1-6.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An exhaust assembly for a vehicle comprising:
a hanger configured to be fixed to a body of the vehicle; and
an exhaust pipe assembly comprising a first portion and a second portion, wherein the first portion includes a first distal end having a reduced outer diameter, the second portion including a second distal end having a reduced outer diameter, wherein the first distal end is at least partially disposed inside the second distal end so that the second distal end overlaps the first distal end at a joining region, wherein the joining region has a first outer diameter and is flanked by outer regions having a second outer diameter that is greater than the first outer diameter, the hanger being joined to an outer surface of the exhaust pipe assembly at the joining region.

2. The exhaust assembly of claim 1, wherein the exhaust pipe assembly has a first wall thickness in the joining region and second and third wall thickness greater than the first wall thickness in the outer regions of the first and second portions, respectively.

3. The exhaust assembly of claim 1, wherein the exhaust pipe assembly has a first wall thickness in the joining region as well as second and third wall thicknesses in the outer regions of the first and second portions, respectively, wherein the first wall thickness is greater than or equal to about 0.8 mm to less than or equal to about 1.6 mm and each of the second and third wall thicknesses are greater than or equal to about 0.4 mm to less than or equal to about 0.8 mm.

4. The exhaust assembly of claim 1, wherein the first portion of the exhaust pipe assembly is sealingly joined to the second portion of the exhaust pipe assembly by a 360° weld.

5. The exhaust assembly of claim 1, wherein an interference fit is provided between the first portion of the exhaust pipe assembly and the second portion of the exhaust pipe assembly at the joining region.

6. The exhaust assembly of claim 1, wherein at least one of the first portion and the second portion has a wall having one or more thickened areas at the joining region.

7. The exhaust assembly, of claim 6, wherein each of an inner surface of the first portion and an outer surface of the second portion has a substantially oval-shaped cross section at the joining region.

8. The exhaust assembly of claim 1, wherein the hanger comprises a wire having a straight region and the hanger is joined to the joining region of the exhaust pipe assembly at the straight region.

9. The exhaust assembly of claim 1, wherein the hanger comprises a wire joined to a frame, the frame comprising opposing legs, each leg comprising
a first edge joined to an outer surface of the wire and a second edge joined to the outer surface of the exhaust pipe assembly.

10. An exhaust assembly for a vehicle comprising:
a hanger joined to an outer surface of an exhaust pipe assembly, the exhaust pipe assembly comprising a first portion and a second portion in fluid communication with and sealingly coupled to the first portion, wherein the second portion overlaps the first portion at a joining region and an interference fit is provided between the first portion and the second portion at the joining region, wherein the joining region has a first outer diameter and the joining region is disposed between outer regions having a second outer and third outer diameters distinct from the first outer diameter.

11. The exhaust assembly of claim 10, wherein the joining region has a first total wall thickness and the outer regions have second and third total wall thicknesses at outer regions of the first and second portions, respectively, that are less than the first total wall thickness.

12. The exhaust assembly of claim 10, wherein the first outer diameter is less than the second outer diameter.

13. The exhaust assembly of claim 10, wherein the first outer diameter is greater than the second outer diameter.

14. The exhaust assembly of claim 13, wherein the first portion comprises an outer surface having an oval-shaped cross section at the joining region and the second portion comprises an inner surface having an oval-shaped cross section at the joining region.

15. The exhaust assembly of claim 10, wherein the joining region has a non-uniform wall thickness comprising one or more thickened areas.

16. A method of assembling an exhaust assembly for a vehicle, comprising:
partially inserting a first exhaust pipe component into a second exhaust pipe component;
reducing a diameter of at least a portion of the second exhaust pipe component to define an interference fit between the first exhaust pipe component and the second exhaust pipe component at a joining region;
sealingly coupling the first exhaust pipe component to the second exhaust pipe component to form an exhaust pipe assembly; and
attaching a hanger to an outer surface of the exhaust pipe assembly at the joining region.

17. The method of claim 16, further comprising increasing a diameter of the first exhaust pipe component.

18. The method of claim 16, wherein sealingly coupling the first exhaust pipe component to the second exhaust pipe component includes welding or brazing a surface of the first exhaust pipe component to a surface of the second exhaust pipe component.
